(19) United States
(12) Patent Application Publication
(10) Pub. No.: US 2022/0291015 A1
(43) Pub. Date: Sep. 15, 2022

(54) MAP GENERATION APPARATUS AND VEHICLE POSITION RECOGNITION APPARATUS

(71) Applicant: Honda Motor Co., Ltd., Tokyo (JP)

(72) Inventor: Naoki Mori, Wako-shi (JP)

(21) Appl. No.: 17/676,738

(22) Filed: Feb. 21, 2022

(30) Foreign Application Priority Data
Mar. 9, 2021 (JP) 2021-037060

(51) Int. Cl. G01C 21/00; G06V 20/56

(52) U.S. Cl. CPC G01C 21/3841; G01C 21/3815; G06V 20/588

(57) ABSTRACT

A map generation apparatus includes: an in-vehicle detection unit configured to detect a situation around a subject vehicle in traveling; and a microprocessor and a memory connected to the microprocessor. The microprocessor is configured to perform: recognizing a division line on a road based on a detection data acquired by the in-vehicle detection unit; generating, while the division line is recognized in the recognizing, a first map based on the division line recognized in the recognizing; and extracting a feature point from the detection data acquired by the in-vehicle detection unit and generating a second map using the feature point extracted in the extracting. The microprocessor is configured to perform the generating the second map including deleting the second map corresponding to a position behind the subject vehicle by a predetermined distance or more from the second map generated while the division line is recognized in the recognizing.

### CROSS-REFERENCE TO RELATED APPLICATION

This application is based upon and claims the benefit of priority from Japanese Patent Application No. 2021-037060 filed on Mar. 9, 2021, the content of which are incorporated herein by reference.

### BACKGROUND OF THE INVENTION

### Field of the Invention

This invention relates to a map generation apparatus configured to generate a map and a vehicle position recognition apparatus configured to recognize a position of a vehicle using the map generated by the map generation apparatus.

### Description of the Related Art

As this type of device, there has been conventionally known a device that generates an entire map by arranging partial maps corresponding to a plurality of points on one map coordinate (see, for example, JP 2020-135579 A (JP 2020-135579 A)). The device described in JP 2020-135579 A reduces the amount of map data by deleting a relatively old partial map from a memory unit when there are partial maps overlapping with each other.

However, the amount of map data itself increases as the accuracy of the map increases and as the target region of the map is enlarged. Therefore, there is a possibility that the amount of map data cannot be sufficiently reduced only by deleting the overlapping partial maps as in the device described in JP 2020-135579 A.

### SUMMARY OF THE INVENTION

An aspect of the present invention is a map generation apparatus including: an in-vehicle detection unit configured to detect a situation around a subject vehicle in traveling; and a microprocessor and a memory connected to the microprocessor. The microprocessor is configured to perform: recognizing a division line on a road based on a detection data acquired by the in-vehicle detection unit; generating, while the division line is recognized in the recognizing, a first map based on the division line recognized in the recognizing; and extracting a feature point from the detection data acquired by the in-vehicle detection unit and generating a second map using the feature point extracted in the extracting, wherein the microprocessor is configured to perform the generating the second map including deleting the second map corresponding to a position behind the subject vehicle by a predetermined distance or more from the second map generated while the division line is recognized in the recognizing.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an overall configuration of a vehicle control system according to an embodiment of the present invention;

FIG. 2 is a block diagram illustrating a configuration of a main part of a vehicle position recognition apparatus including a map generation apparatus according to an embodiment of the present invention;

FIG. 3A is a diagram illustrating how a vehicle travels on a road while generating an environmental map;

FIG. 3B is a diagram illustrating how a vehicle travels at the point in FIG. 3A in a self-drive mode;

FIG. 4 is a flowchart illustrating an example of processing executed by the controller in FIG. 2; and

FIG. 5 is a diagram illustrating how a vehicle travels in the self-drive mode based on a map generated by the processing of FIG. 4.

### DETAILED DESCRIPTION OF THE INVENTION

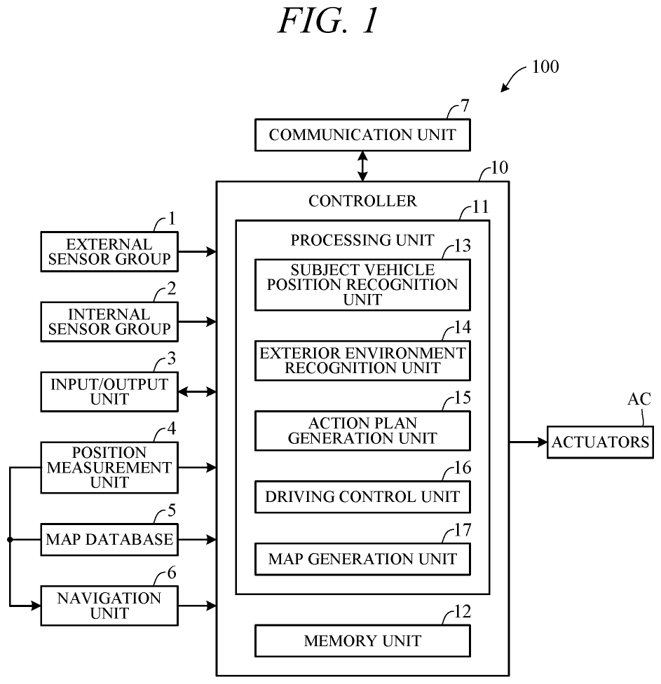

Hereinafter, an embodiment of the present invention will be described with reference to FIGS. 1 to 5. A map generation apparatus according to the embodiment of the present invention can be applied to a vehicle including a self-driving capability, that is, a self-driving vehicle. It is to be noted that a vehicle to which the map generation apparatus according to the present embodiment is applied may be referred to as a subject vehicle as distinguished from other vehicles. The subject vehicle may be any of an engine vehicle including an internal combustion (engine) as a traveling drive source, an electric vehicle including a traveling motor as a traveling drive source, and a hybrid vehicle including an engine and a traveling motor as a traveling drive source. The subject vehicle can travel not only in a self-drive mode in which driving operation by a driver is unnecessary, but also in a manual drive mode with driving operation by the driver.

First, a schematic configuration related to self-driving will be described. FIG. 1 is a block diagram schematically illustrating an overall configuration of a vehicle control system 100 including a map generation apparatus according to the embodiment of the present invention. As illustrated in FIG. 1, the vehicle control system 100 mainly includes a controller 10, an external sensor group 1, an internal sensor group 2, an input/output device 3, a position measurement unit 4, a map database 5, a navigation unit 6, a communication unit 7, and traveling actuators AC each communicably connected to the controller 10.

The external sensor group 1 is a generic term for a plurality of sensors (external sensors) that detect an external situation which is peripheral information of the subject vehicle. For example, the external sensor group 1 includes a LiDAR that measures scattered light with respect to irradiation light in all directions of the subject vehicle and measures a distance from the subject vehicle to surrounding obstacles, a radar that detects other vehicles, obstacles, and the like around the subject vehicle by irradiating with electromagnetic waves and detecting reflected waves, and a camera that is mounted on the subject vehicle, has an imaging element such as a charge coupled device (CCD) or a complementary metal oxide semiconductor (CMOS), and images a periphery (forward, backward, and sideward) of the subject vehicle.

The internal sensor group 2 is a generic term for a plurality of sensors (internal sensors) that detect a traveling state of the subject vehicle. For example, the internal sensor group 2 includes a vehicle speed sensor that detects a vehicle speed of the subject vehicle, an acceleration sensor that detects an acceleration in a front-rear direction of the subject vehicle and an acceleration in a left-right direction (lateral acceleration) of the subject vehicle, a revolution sensor that detects the number of revolution of the traveling drive source, and a yaw rate sensor that detects a rotation angular speed around a vertical axis of the center of gravity of the subject vehicle. The internal sensor group 2 further includes a sensor that detects driver's driving operation in a manual drive mode, for example, operation of an accelerator pedal, operation of a brake pedal, operation of a steering wheel, and the like.

The input/output device 3 is a generic term for devices in which a command is input from a driver or information is output to the driver. For example, the input/output device 3 includes various switches to which the driver inputs various commands by operating an operation member, a microphone to which the driver inputs a command by voice, a display that provides information to the driver via a display image, and a speaker that provides information to the driver by voice.

The position measurement unit (global navigation satellite system (GNSS) unit) 4 includes a positioning sensor that receives a signal for positioning, transmitted from a positioning satellite. The positioning satellite is an artificial satellite such as a global positioning system (GPS) satellite or a quasi-zenith satellite. The position measurement unit 4 uses positioning information received by the positioning sensor to measure a current position (latitude, longitude, and altitude) of the subject vehicle.

The map database 5 is a device that stores general map information used for the navigation unit 6, and is constituted of, for example, a hard disk or a semiconductor element. The map information includes road position information, information on a road shape (curvature or the like), position information on intersections and branch points, and information on a speed limit set for a road. The map information stored in the map database 5 is different from highly accurate map information stored in a memory unit 12 of the controller 10.

The navigation unit 6 is a device that searches for a target route on a road to a destination input by a driver and provides guidance along the target route. The input of the destination and the guidance along the target route are performed via the input/output device 3. The target route is calculated based on a current position of the subject vehicle measured by the position measurement unit 4 and the map information stored in the map database 5. The current position of the subject vehicle can be measured using the detection values of the external sensor group 1, and the target route may be calculated on the basis of the current position and the highly accurate map information stored in the memory unit 12.

The communication unit 7 communicates with various servers not illustrated via a network including wireless communication networks represented by the Internet, a mobile telephone network, and the like, and acquires the map information, traveling history information, traffic information, and the like from the servers periodically or at an arbitrary timing. The network includes not only public wireless communication networks, but also a closed communication network provided for every predetermined management area, for example, a wireless local area network (LAN), Wi-Fi (registered trademark), Bluetooth (registered trademark), and the like. The acquired map information is output to the map database 5 and the memory unit 12, and the map information is updated.

The actuators AC are traveling actuators for controlling traveling of the subject vehicle. In a case where the traveling drive source is an engine, the actuators AC include a throttle actuator that adjusts an opening (throttle opening) of a throttle valve of the engine. In a case where the traveling drive source is a traveling motor, the traveling motor is included in the actuators AC. The actuators AC also include a brake actuator that operates a braking device of the subject vehicle and a steering actuator that drives a steering device.

The controller 10 includes an electronic control unit (ECU). More specifically, the controller 10 includes a computer including a processing unit 11 such as a CPU (microprocessor), the memory unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 1, the controller 10 is illustrated as a set of these ECUs for convenience.

The memory unit 12 stores highly accurate detailed map information (referred to as highly accurate map information). The highly accurate map information includes road position information, information of a road shape (curvature or the like), information of a road gradient, position information of an intersection or a branch point, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface. The highly accurate map information stored in the memory unit 12 includes map information acquired from the outside of the subject vehicle via the communication unit 7, for example, information of a map (referred to as a cloud map) acquired via a cloud server, and information of a map created by the subject vehicle itself using detection values by the external sensor group 1, for example, information of a map (referred to as an environmental map) including point cloud data generated by mapping using a technology such as simultaneous localization and mapping (SLAM). The memory unit 12 also stores information on various control programs and thresholds used in the programs.

The processing unit 11 includes a subject vehicle position recognition unit 13, an exterior environment recognition unit 14, an action plan generation unit 15, a driving control unit 16, and a map generation unit 17 as functional configurations.

The subject vehicle position recognition unit 13 recognizes the position (subject vehicle position) of the subject vehicle on a map, based on the position information of the subject vehicle, obtained by the position measurement unit 4, and the map information of the map database 5. The subject vehicle position may be recognized using the map information stored in the memory unit 12 and the peripheral information of the subject vehicle detected by the external sensor group 1, whereby the subject vehicle position can be recognized with high accuracy. When the subject vehicle position can be measured by a sensor installed on a road or outside a road side, the subject vehicle position can be recognized by communicating with the sensor via the communication unit 7.

The exterior environment recognition unit 14 recognizes an external situation around the subject vehicle, based on the signal from the external sensor group 1 such as a LiDAR, a radar, and a camera. For example, the position, travelling speed, and acceleration of a surrounding vehicle (a forward vehicle or a rearward vehicle) traveling around the subject vehicle, the position of a surrounding vehicle stopped or parked around the subject vehicle, and the positions and states of other objects are recognized. Other objects include signs, traffic lights, markings (road surface markings) such as division lines and stop lines of roads, buildings, guardrails, utility poles, signboards, pedestrians, and bicycles. The states of other objects include a color of a traffic light (red, green, yellow), and the moving speed and direction of a pedestrian or a bicycle. A part of the stationary object among the other objects constitutes a landmark serving as an index of the position on the map, and the exterior environment recognition unit 14 also recognizes the position and type of the landmark.

The action plan generation unit 15 generates a driving path (target path) of the subject vehicle from a current point of time to a predetermined time ahead based on, for example, the target route calculated by the navigation unit 6, the subject vehicle position recognized by the subject vehicle position recognition unit 13, and the external situation recognized by the exterior environment recognition unit 14. When there are a plurality of paths that are candidates for the target path on the target route, the action plan generation unit 15 selects, from among the plurality of paths, an optimal path that satisfies criteria such as compliance with laws and regulations, and efficient and safe traveling, and sets the selected path as the target path. Then, the action plan generation unit 15 generates an action plan corresponding to the generated target path. The action plan generation unit 15 generates various action plans corresponding to traveling modes, such as overtaking traveling for overtaking a preceding vehicle, lane change traveling for changing a traveling lane, following traveling for following a preceding vehicle, lane keeping traveling for keeping the lane so as not to deviate from the travel lane, deceleration traveling, or acceleration traveling. When the action plan generation unit 15 generates the target path, the action plan generation unit 15 first determines a travel mode, and generates the target path based on the travel mode.

In the self-drive mode, the driving control unit 16 controls each of the actuators AC such that the subject vehicle travels along the target path generated by the action plan generation unit 15. More specifically, the driving control unit 16 calculates a requested driving force for obtaining the target acceleration for each unit time calculated by the action plan generation unit 15 in consideration of travel resistance determined by a road gradient or the like in the self-drive mode. Then, for example, the actuators AC are feedback controlled so that an actual acceleration detected by the internal sensor group 2 becomes the target acceleration. More specifically, the actuators AC are controlled so that the subject vehicle travels at the target vehicle speed and the target acceleration. In the manual drive mode, the driving control unit 16 controls each of the actuators AC in accordance with a travel command (steering operation or the like) from the driver, acquired by the internal sensor group 2.

The map generation unit 17 generates an environmental map constituted by three-dimensional point cloud data using detection values detected by the external sensor group 1 during traveling in the manual drive mode. Specifically, an edge indicating an outline of an object is extracted from a captured image acquired by a camera 1a based on luminance and color information for each pixel, and a feature point is extracted using the edge information. The feature point is, for example, an intersection of edges, and corresponds to a corner of a building, a corner of a road sign, or the like. The map generation unit 17 sequentially plots the extracted feature points on the environmental map, thereby generating the environmental map around the road on which the subject vehicle has traveled. The environmental map may be generated by extracting the feature points of an object around the subject vehicle with the use of data acquired by a radar or LiDAR instead of the camera. In addition, when generating the environmental map, the map generation unit 17 determines whether or not a landmark such as a traffic light, a sign, and a building as a mark on the map is included in the captured image acquired by the camera by using, for example, pattern matching processing. When it is determined that the landmark is included, the position and the type of the landmark on the environmental map are recognized based on the captured image. The landmark information is included in the environmental map and stored in the memory unit 12.

The subject vehicle position recognition unit 13 performs subject vehicle position estimation processing in parallel with map creation processing by the map generation unit 17. That is, the position of the subject vehicle is estimated and acquired based on a change in the position of the feature point over time. In addition, the subject vehicle position recognition unit 13 estimates and acquires the subject vehicle position on the basis of a relative positional relationship between a landmark around the subject vehicle and a feature point of an object around the subject vehicle. The map creation processing and the position estimation processing are simultaneously performed, for example, according to an algorithm of SLAM. The map generation unit 17 can generate the environmental map not only when the vehicle travels in the manual drive mode but also when the vehicle travels in the self-drive mode. If the environmental map has already been generated and stored in the memory unit 12, the map generation unit 17 may update the environmental map with a newly obtained feature point.

Incidentally, the environmental map including the point cloud data has a large amount of data, and the amount of data increases as the region to be mapped becomes wider. Therefore, when an attempt is made to create an environmental map for a wide region, the capacity of the memory unit 12 may be greatly deprived. Therefore, in order to be able to create a wide-area environmental map while suppressing an increase in the amount of data, in the present embodiment, the map generation apparatus is configured as follows.

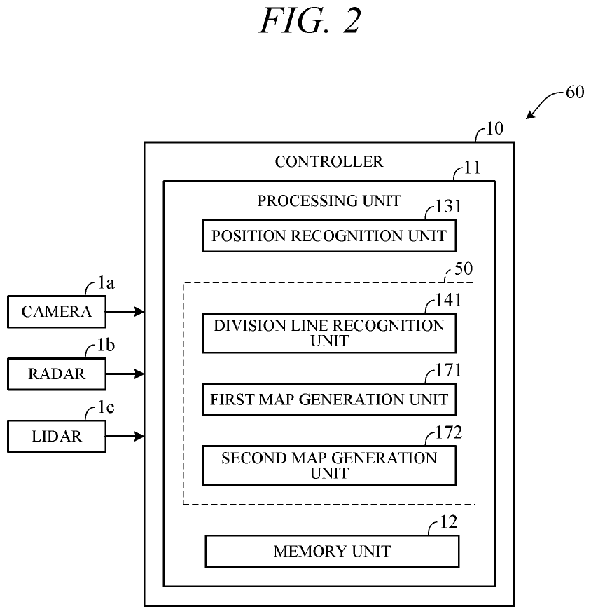

FIG. 2 is a block diagram illustrating a configuration of a main part of a vehicle position recognition apparatus including a map generation apparatus according to the embodiment of the present invention. The vehicle position recognition apparatus 60 acquires the current position of the vehicle of the subject vehicle, and constitutes a part of the vehicle control system 100 in FIG. 1. As illustrated in FIG. 2, the vehicle position recognition apparatus 60 includes the controller 10, the camera 1a, a radar 1b, and a LiDAR 1c. In addition, the vehicle position recognition apparatus 60 includes a map generation apparatus 50 constituting a part of the vehicle position recognition apparatus 60. The map generation apparatus 50 generates a map (division line map and environmental map to be described later) on the basis of a captured image of the camera 1a.

The camera 1a is a monocular camera having an imaging element (image sensor) such as a CCD or a CMOS, and constitutes a part of the external sensor group 1 in FIG. 1. The camera 1a may be a stereo camera. The camera 1a images the surroundings of the subject vehicle. The camera 1a is mounted at a predetermined position, for example, in front of the subject vehicle, and continuously captures an image of a space in front of the subject vehicle to acquire an image data (Hereinafter, it is referred to as captured image data or simply a captured image.) of the object. The camera 1a outputs the captured image to the controller 10. The radar 1b is mounted on the subject vehicle and detects other vehicles, obstacles, and the like around the subject vehicle by irradiating with electromagnetic waves and detecting reflected waves. The radar 1b outputs a detection value (detection data) to the controller 10. The LiDAR 1c is mounted on the subject vehicle, and measures scattered light with respect to irradiation light in all directions of the subject vehicle and detects a distance from the subject vehicle to surrounding vehicles and obstacles. The LiDAR 1c outputs the detection value (detection data) to the controller 10.

The controller 10 includes a position recognition unit 131, a division line recognition unit 141, a first map generation unit 171, and a second map generation unit 172 as a functional configuration carried by the processing unit 11 (FIG. 1). Note that the division line recognition unit 141, the first map generation unit 171, and the second map generation unit 172 are included in the map generation apparatus 50. The position recognition unit 131 includes, for example, a subject vehicle position recognition unit 13. The division line recognition unit 141 is configured by, for example, the exterior environment recognition unit 14 in FIG. 1. The first map generation unit 171 and the second map generation unit 172 are configured by, for example, the map generation unit 17 in FIG. 1.

The division line recognition unit 141 recognizes a division line of a road based on the captured image acquired by the camera 1a. While the division line is recognized by the division line recognition unit 141, the first map generation unit 171 generates a division line map based on the recognized position of the division line. The division line map includes information on the position of the division line. Hereinafter, the division line map is also referred to as a first map.

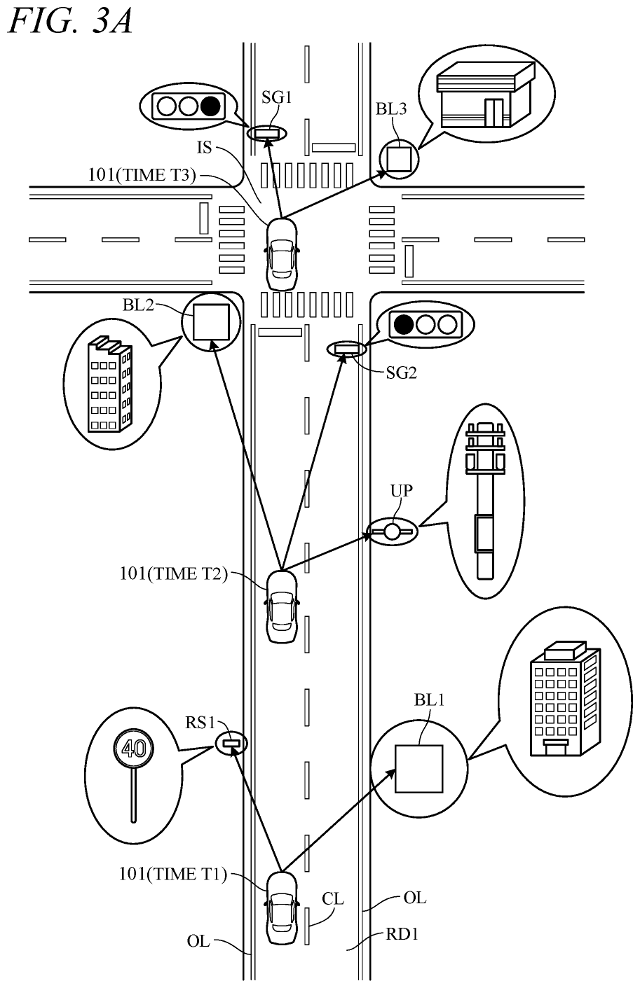

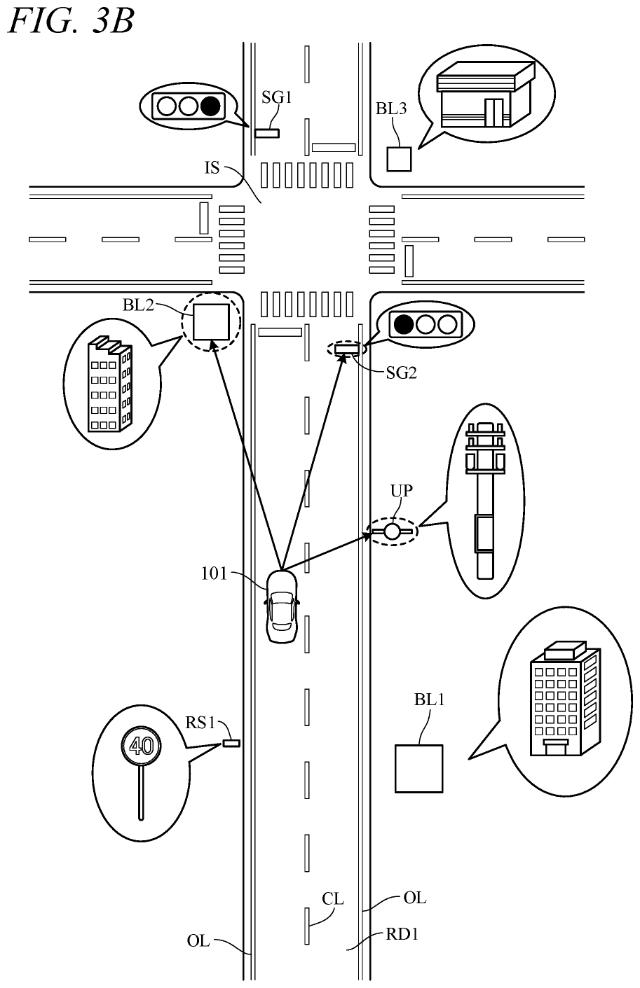

The second map generation unit 172 extracts a feature point from the captured image acquired by the camera 1a, and generates an environmental map using the extracted feature point. Hereinafter, the environmental map generated by the second map generation unit 172 is also referred to as a second map. FIG. 3A is a diagram illustrating how a subject vehicle 101 travels on a road while generating the environmental map. In the example illustrated in FIG. 3A, the subject vehicle 101 is traveling toward an intersection IS on a road RD1 having one lane on one side of left-hand traffic. FIG. 3A schematically illustrates the subject vehicle 101 at each of time t1, time t2 after time t1, and time t3 after time t2. As illustrated in FIG. 3A, at the time t1, the captured range of the in-vehicle camera (camera 1a) of the subject vehicle 101 includes a building BL1 and a road sign RS1. At the time t2, a building BL2, a utility pole UP, and a traffic light SG2 in the opposite lane are included. At the time t3, a traffic light SG1 on the lane on which the subject vehicle 101 travels and a building BL3 are included. The second map generation unit 172 extracts feature points of these objects from the captured image of the camera 1a. An object surrounded by a round frame in the drawing represents an object from which a feature point is extracted by the second map generation unit 172 at each of the times t1, t2, and t3. Note that the captured range of the camera 1a includes division lines (the center line CL and the roadway outer lines OL) on the road at all time points from the time t1 to t3, and the second map generation unit 172 also extracts feature points of the division lines on the road from the captured image of the camera 1a. As described above, since the environmental map includes information (feature points) on objects around roads and division lines on the roads, the amount of data is larger than that of the division line map that does not include information other than the division lines on the roads.

While the subject vehicle 101 is traveling in the self-drive mode, the position recognition unit 131 recognizes the position of the subject vehicle 101 based on the captured image of the camera 1a and at least one of the division line map generated by the first map generation unit 171 and the environmental map generated by the second map generation unit 172.

FIG. 3B is a diagram illustrating how the subject vehicle 101 travels at a point in FIG. 3A in the self-drive mode. The position of the subject vehicle 101 in FIG. 3B is assumed to be the same as the position of the subject vehicle 101 at the time t2 in FIG. 3A. Therefore, the captured range of the in-vehicle camera (camera 1a) of the subject vehicle 101 in FIG. 3B includes the building BL2, the utility pole UP, the traffic light SG2 in the opposite lane, the center line CL of the road, and the roadway outer lines OL.

When recognizing the position of the subject vehicle 101 based on the division line map, the position recognition unit 131 first recognizes division lines (the center line CL and the roadway outer lines OL) included in the captured image of the camera 1a by pattern matching processing or the like. Then, the position recognition unit 131 collates the recognized division lines with the division line map, and when a point coinciding with the recognized division lines exists on the division line map, recognizes the point as the position of the subject vehicle 101.

On the other hand, when recognizing the position of the subject vehicle 101 on the basis of the environmental map, the position recognition unit 131 first collates a feature point of an object such as a division line or the building BL2 extracted from the captured image of the camera 1a with the environmental map. Then, when feature points that match the feature points of these objects are recognized on the environmental map, the position recognition unit 131 recognizes the position of the subject vehicle 101 on the environmental map on the basis of the positions of the recognized feature points on the environmental map. An object surrounded by a broken-line round frame in FIG. 3B represents an object from which a feature point is extracted by the position recognition unit 131 at the time of FIG. 3B.

When there is no division line on a road on which the subject vehicle 101 travels or when the division line on the road on which the subject vehicle 101 travels is blurred, the division line is not recognized from the captured image of the camera 1a. In such a case, the position recognition unit 131 cannot recognize the position of the subject vehicle 101 on the division line map. On the other hand, if the feature points of other objects are extracted even if the feature points of the division lines are not extracted from the captured image of the camera 1a, the position recognition unit 131 can recognize the position of the subject vehicle 101 on the environmental map on the basis of these feature points.

Therefore, in a section where the division line is not recognized by the division line recognition unit 141, the position recognition unit 131 recognizes the position of the subject vehicle 101 on the environmental map based on the captured image of the camera 1a and the environmental map. On the other hand, in a section where the division line is recognized by the division line recognition unit 141, the position recognition unit 131 recognizes the position of the subject vehicle 101 on the division line map based on the captured image of the camera 1a and the division line map. In this manner, the division line map is preferentially used in a section where the position of the subject vehicle 101 can be recognized on the basis of either the division line map or the environmental map. This eliminates the need for the environmental map in the section where the division line can be recognized, so that the amount of data for the environmental map can be reduced.

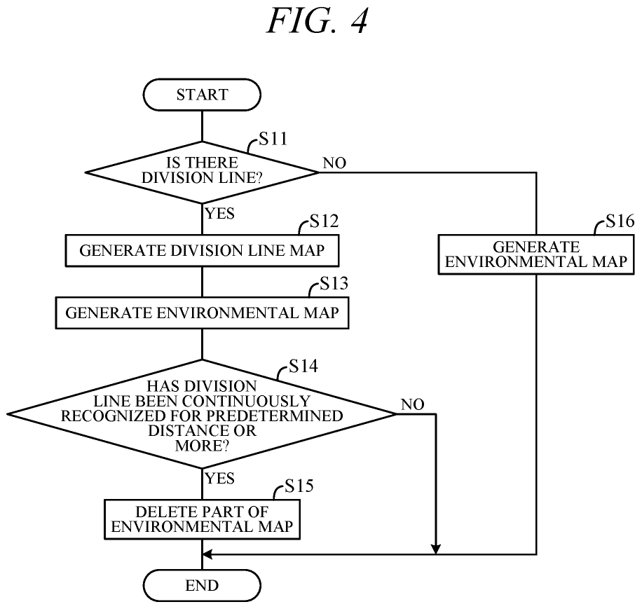

FIG. 4 is a flowchart illustrating an example of processing (map generation processing) executed by the controller 10 in FIG. 2 according to a predetermined program, particularly an example of processing regarding map generation. The processing illustrated in the flowchart of FIG. 4 is repeated at a predetermined cycle while the subject vehicle 101 travels in the self-drive mode.

First, in S11 (S: processing step), it is determined whether or not a division line has been recognized from the captured image of the camera 1a. When the determination is YES in S11, a division line map is generated and stored in the memory unit 12 in S12. When the division line map has already been stored in the memory unit 12, information on the division lines recognized in S11 is added to the division line map stored in the memory unit 12 to update the division line map. As a result, a division line map of the road on which the subject vehicle 101 travels is formed. In step S13, an environmental map is generated based on a feature point cloud extracted from the captured image of the camera 1a and stored in the memory unit 12. When the environmental map has been already stored in the memory unit 12, the environmental map is updated with the extracted feature point cloud.

Note that the environmental map includes data (point cloud data) of feature points extracted from the captured image acquired by the camera 1a and a pose graph. The pose graph includes nodes and edges. The node represents a position and attitude of the subject vehicle 101 at the time when the point cloud data is acquired, and the edge represents a relationship between the relative position (distance) and the attitude between the nodes. When the environmental map is a three-dimensional map, the attitude is expressed by a pitch angle, a yaw angle, or a roll angle. In the update of the environmental map, the point cloud data acquired at the current position of the subject vehicle 101 is newly added, and the node corresponding to the added point cloud data and the edge indicating the relationship between the node and the existing node are added to the pose graph.

In step S14, it is determined whether the division line has been continuously recognized for a predetermined distance or more. Specifically, it is determined whether or not the distance from the point where the division line recognized in S11 starts to be recognized (Hereinafter, referred to as a division line start point) to the current position of the subject vehicle 101 is a predetermined distance or more. If the determination is NO in step S14, the processing ends. When the determination is YES in S14, a part of the environmental map is deleted in S15. Specifically, the environmental map from the division line start point to a predetermined point behind the current position of the subject vehicle 101 by a predetermined distance is deleted from the memory unit 12.

On the other hand, when the determination is NO in S11, an environmental map is generated based on a feature point cloud extracted from the captured image of the camera 1a and stored in the memory unit 12 in step S16. When the environmental map has been already stored in the memory unit 12, the environmental map is updated with the extracted feature point cloud.

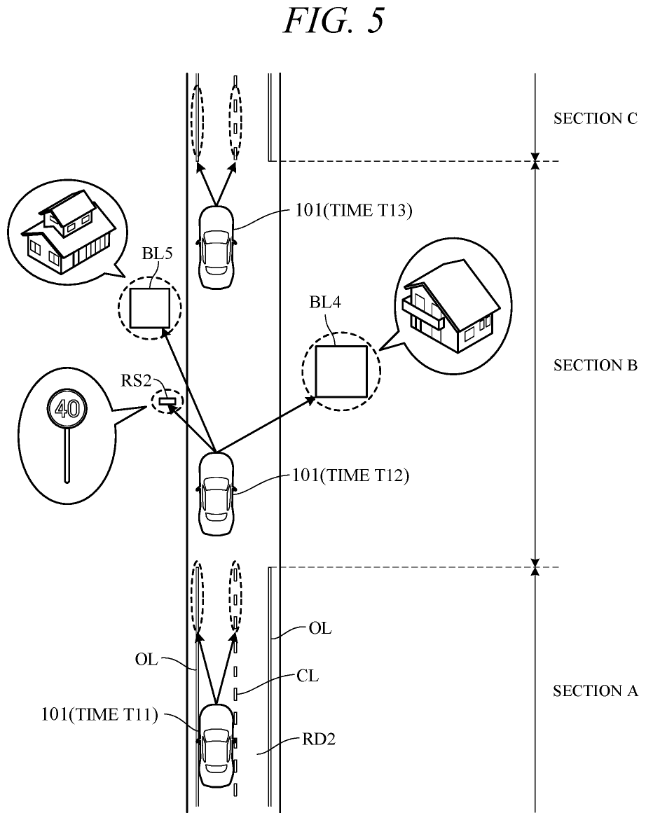

FIG. 5 is a diagram illustrating how the subject vehicle 101 travels in the self-drive mode based on the map (the division line map and the environmental map) generated by the map generation processing of FIG. 4. In the example illustrated in FIG. 5, the subject vehicle 101 is traveling on a road RD2 having one lane on one side of left-hand traffic. FIG. 5 schematically illustrates the subject vehicle 101 at each of time t11, time t12 after time t11, and time t13 after time t12. In the road RD2, there is a section B where there is no division line between the section A and the section C. When the subject vehicle 101 travels in the section A and the section B, the position recognition unit 131 recognizes the position of the subject vehicle 101 on the division line map based on the division lines CL and OL recognized based on the captured image of the camera 1a and the division line map corresponding to the section A and the section C. On the other hand, when the subject vehicle 101 travels in the section B, the position recognition unit 131 recognizes the position of the subject vehicle 101 on the environmental map based on the feature points of the buildings BL4 and BL5, and the road sign RS2 extracted from the captured image of the camera 1a, and the environmental map corresponding to the section B. When recognition of the subject vehicle position based on the environmental map is started at the boundary between the section A and the section B, the position recognition unit 131 calculates the position of the subject vehicle 101 on the environmental map based on the position of the subject vehicle 101 on the division line map recognized immediately before.

Normally, when a subject vehicle position recognition based on the environmental map is started, a subject vehicle position (initial position) on the environmental map is searched. Since the search involves complicated arithmetic processing, the processing load of the processing unit 11 is increased. However, as described above, by calculating the initial position of the subject vehicle 101 on the environmental map based on the position of the subject vehicle 101 on the division line map recognized immediately before, it is not necessary to search for the initial position, so that the processing load of the processing unit 11 can be reduced. As a result, recognition of the subject vehicle position based on the environmental map can be smoothly started at the boundary between the section A and the section B.

According to the embodiment of the present invention, the following advantageous effects can be obtained:

(1) A map generation apparatus 50 is a map generation apparatus that generates a map used to acquire the position of the subject vehicle 101. The map generation apparatus 50 includes a camera 1a that detects a situation around a subject vehicle 101 during traveling, a division line recognition unit 141 that recognizes division lines on a road based on detection data (captured image) acquired by the camera 1a, a first map generation unit 171 that generates a first map (division line map) based on the recognized division lines while the division lines are recognized by the division line recognition unit 141, and a second map generation unit 172 that extracts feature points from the captured image of the camera 1a and generates a second map (environmental map) using the extracted feature points. The second map generation unit 172 deletes the second map corresponding to a position behind the subject vehicle 101 by a predetermined distance or more from the second map generated while the division line is recognized by the division line recognition unit 141. As a result, the amount of map data can be reduced.

(2) A vehicle position recognition apparatus 60 includes the map generation apparatus 50 and a position recognition unit 131 that recognizes the position of the subject vehicle 101 during traveling. When the division line is recognized by the division line recognition unit 141, the position recognition unit 131 recognizes the position of the subject vehicle 101 on the first map based on the captured image of the camera 1a and the first map, and when the division line is not recognized by the division line recognition unit 141, the position recognition unit recognizes the position of the subject vehicle 101 on the second map based on the captured image of the camera 1a and the second map. As a result, in the section where the division line exists, if there is the division line map, the subject vehicle position can be recognized, and it is not necessary to generate the environmental map of such section. Therefore, the amount of map data can be reduced.

(3) When the division line is no longer recognized by the division line recognition unit 141, the position recognition unit 131 calculates the initial position of the subject vehicle 101 on the second map based on the position of the subject vehicle 101 on the first map, and starts to recognize the position of the subject vehicle 101 on the second map based on the calculated initial position. As a result, when the subject vehicle 101 moves from a section (for example, section A in FIG. 5) where the division line exists in the section to a section (for example, section B in FIG. 5) where the division line does not exist, it is not necessary to search for the position (initial position) of the subject vehicle 101 on the second map. Therefore, the processing load at the time of starting the recognition of the subject vehicle position based on the second map can be reduced, and the recognition of the subject vehicle position based on the second map can be smoothly started.

The above-described embodiment can be modified into various forms. Hereinafter, modified examples will be described. According to the embodiment mentioned above, the camera 1a is configured to detect the situation around the subject vehicle 101, however, the configuration of the in-vehicle detection unit is not limited to the above-described configuration as long as the situation around the subject vehicle 101 is detected. For example, the in-vehicle detection unit may be the radar 1b or the LiDAR 1c. In the above embodiment, the processing illustrated in FIG. 4 is executed while traveling in the manual drive mode. However, the processing illustrated in FIG. 4 may be executed while traveling in the self-drive mode.

In the above embodiment, the case where the first map is the division line map has been described as an example, but the first map is not limited to the division line map. The first map may be a map other than the division line map as long as the first map is a map capable of recognizing the position of the subject vehicle 101 based on the detection data of the in-vehicle detection unit and has a smaller amount of data than that of the second map. Furthermore, in the above embodiment, the map generation apparatus 50 is applied to a self-driving vehicle, but the map generation apparatus 50 is also applicable to a vehicle other than the self-driving vehicle. For example, the map generation apparatus 50 can also be applied to a manual driving vehicle including advanced driver-assistance systems (ADAS).

The present invention also can be configured as a map generation method including: recognizing a division line on a road based on a detection data acquired by an in-vehicle detection unit configured to detect a situation around a subject vehicle in traveling; generating, while the division line is recognized in the recognizing, a first map based on the division line recognized in the recognizing; and extracting a feature point from the detection data acquired by the in-vehicle detection unit and generating a second map using the feature point extracted in the extracting. The generating the second map including deleting the second map corresponding to a position behind the subject vehicle by a predetermined distance or more from the second map generated while the division line is recognized in the recognizing.

The above embodiment can be combined as desired with one or more of the above modifications. The modifications can also be combined with one another.

According to the present invention, it is possible to sufficiently reduce the amount of map data.

Above, while the present invention has been described with reference to the preferred embodiments thereof, it will be understood, by those skilled in the art, that various changes and modifications may be made thereto without departing from the scope of the appended claims.

What is claimed is:

1. A map generation apparatus comprising:
an in-vehicle detection unit configured to detect a situation around a subject vehicle in traveling; and
a microprocessor and a memory connected to the microprocessor, wherein
the microprocessor is configured to perform:
recognizing a division line on a road based on a detection data acquired by the in-vehicle detection unit;
generating, while the division line is recognized in the recognizing, a first map based on the division line recognized in the recognizing; and
extracting a feature point from the detection data acquired by the in-vehicle detection unit and generating a second map using the feature point extracted in the extracting, wherein
the microprocessor is configured to perform
the generating the second map including deleting the second map corresponding to a position behind the subject vehicle by a predetermined distance or more from the second map generated while the division line is recognized in the recognizing.

2. The map generation apparatus according to claim 1, wherein
the first map includes an information of a position of the division line.

3. A vehicle position recognition apparatus comprising:
an in-vehicle detection unit configured to detect a situation around a subject vehicle in traveling; and
a microprocessor and a memory connected to the microprocessor, wherein
the microprocessor is configured to perform:
recognizing a division line on a road based on a detection data acquired by the in-vehicle detection unit;
generating, while the division line is recognized in the recognizing, a first map based on the division line recognized in the recognizing;
extracting a feature point from the detection data acquired by the in-vehicle detection unit and generating a second map using the feature point extracted in the extracting; and
when the division line is recognized in the recognizing, recognizing a position of the subject vehicle on the first map based on the detection data acquired in the recognizing and the first map, and when the division line is not recognized in the recognizing, recognizing a position of the subject vehicle on the second map based on the detection data acquired by the in-vehicle detection unit and the second map, wherein
the microprocessor is configured to perform
the generating the second map including deleting the second map corresponding to a position behind the subject vehicle by a predetermined distance or more from the second map generated while the division line is recognized in the recognizing.

4. The vehicle position recognition apparatus according to claim 3, wherein
the microprocessor is configured to perform
the recognizing including, when the division line is no longer recognized in the recognizing, calculating an initial position of the subject vehicle on the second map based on the position of the subject vehicle on the first map, and starting to recognize the position of the subject vehicle on the second map based on the initial position calculated in the calculating.

5. A map generation method comprising:
recognizing a division line on a road based on a detection data acquired by an in-vehicle detection unit configured to detect a situation around a subject vehicle in traveling;
generating, while the division line is recognized by in the recognizing, a first map based on the division line recognized in the recognizing; and
extracting a feature point from the detection data acquired by the in-vehicle detection unit and generating a second map using the feature point extracted in the extracting, wherein
the generating the second map including deleting the second map corresponding to a position behind the subject vehicle by a predetermined distance or more from the second map generated while the division line is recognized in the recognizing.
